(19) United States
(12) Patent Application Publication
(10) Pub. No.: US 2024/0135640 A1
(43) Pub. Date: Apr. 25, 2024

(54) NON-TRANSITORY COMPUTER-READABLE STORAGE MEDIUM, OBJECT PROCESSING METHOD, AND OBJECT PROCESSING APPARATUS

(71) Applicant: Cluster, Inc., Tokyo (JP)

(72) Inventors: Daiki HANDA, Tokyo (JP); Yuto MARISAKI, Tokyo (JP); Hiroyuki TOMINE, Tokyo (JP); Shoma SATO, Tokyo (JP)

(73) Assignee: Cluster, Inc., Tokyo (JP)

(21) Appl. No.: 18/381,664

(22) Filed: Oct. 18, 2023

(30) Foreign Application Priority Data
Oct. 18, 2022 (JP) 2022-167385

(51) Int. Cl. G06T 17/00

(52) U.S. Cl. CPC G06T 17/00

(57) ABSTRACT

An object processing apparatus includes a data acquisition unit configured to acquire object data including display information of an object displayed in a virtual space and a script for executing processing in the virtual space; an attribute value acquisition unit configured to acquire one or more object attribute values related to the object data; a determination unit configured to acquire a determination result as to whether to execute the script included in the object data, the determination result being a result of determination performed by using the one or more object attribute values; and a control unit configured to restrict execution of the script according to the determination result. Accordingly, the object processing apparatus avoids risk by restricting execution of the script as necessary.

### CROSS-REFERENCE TO RELATED APPLICATION

This application claims priority to Japanese application no. 2022-167385, filed Oct. 19, 2022, the entire contents of which is hereby incorporated by reference.

### BACKGROUND

### 1. Technical Field

The present disclosure relates to a program or the like that performs processing related to an object arranged in a virtual space.

### 2. Description of the Related Art

In the related art, there has been a game system for reducing a possibility of falsification of information and fraud in a game and allowing a user to enjoy the game (see JP 2022-29608 A).

Such a system is an information processing system including: a storage unit configured to store first information related to a past event of a game and second information related to a result of determining whether the first information satisfies a predetermined condition in association with a medium in the game; and an execution unit configured to execute predetermined processing related to the game based on contents of the first information and the second information associated with the medium, in which at least one of the first information and the second information is subjected to a measure for reducing a possibility of falsification of information.

### SUMMARY

However, in the related art, when an object including a script is used in a virtual space, it is not possible to cope with a risk that may occur due to execution of the script.

Note that the object used in the virtual space may be an object that has originally existed in the virtual space or an object that has come to exist in the virtual space at an arbitrary timing.

The present disclosure describes an object processing apparatus including: a data acquisition unit configured to acquire object data including display information of an object displayed in a virtual space and a script for executing processing in the virtual space; an attribute value acquisition unit configured to acquire one or more object attribute values related to the object data; a determination unit configured to acquire a determination result as to whether to execute the script included in the object data, the determination result being a result of determination performed by using the one or more object attribute values; a control unit configured to restrict execution of the script according to the determination result; and an output unit configured to output the object by using the display information included in the object data.

With such a configuration, it is possible to avoid a risk by restricting the execution of the script as necessary.

Further, the present disclosure describes an object processing apparatus in which the one or more object attribute values include a producer attribute value that is an attribute value of a producer of the object data.

With such a configuration, it is possible to appropriately avoid a risk by performing determination using an appropriate object attribute value and restricting the execution of the script according to the determination result.

Further, the present disclosure describes an object processing apparatus in which the one or more object attribute values include a disposal right holder attribute value that is an attribute value of a disposal right holder of the object data.

With such a configuration, it is possible to appropriately avoid a risk by performing determination using an appropriate object attribute value and restricting the execution of the script according to the determination result.

Further, the present disclosure describes an object processing apparatus in which the one or more object attribute values include a virtual space attribute value that is an attribute value set in the virtual space.

With such a configuration, it is possible to appropriately avoid a risk by performing determination using an appropriate object attribute value and restricting the execution of the script according to the determination result.

Further, the present disclosure describes an object processing apparatus, with respect to the first invention, in which the one or more object attribute values include a dynamic attribute value that dynamically changes.

With such a configuration, it is possible to appropriately avoid a risk by performing determination using an appropriate object attribute value and restricting the execution of the script according to the determination result.

Further, the present disclosure describes an object processing apparatus in which the one or more object attribute values include a static attribute value that does not dynamically change.

With such a configuration, it is possible to appropriately avoid a risk by performing determination using an appropriate object attribute value and restricting the execution of the script according to the determination result.

Further, the present disclosure describes an object processing apparatus in which the control unit performs restriction processing for not executing the script in a case where the determination result is information indicating that the script is not executed, and the restriction processing is processing for not executing a part of a plurality of processing included in the script.

With such a configuration, it is possible to avoid a risk by restricting the execution of the script as necessary.

Further, the present disclosure describes an object processing apparatus in which the control unit performs the restriction processing for not executing the script in a case where the determination result is information indicating that the script is not executed, and the restriction processing is processing for not executing a part of the script among the scripts.

With such a configuration, it is possible to appropriately avoid a risk by restricting the execution of the part of the script as necessary.

Further, the present disclosure describes an object processing apparatus in which the script includes a subprogram that executes two or more processing, the determination unit acquires a determination result as to whether to execute for each of the subprograms, and the control unit executes only the subprogram determined to be executed by the determination unit.

With such a configuration, it is possible to appropriately avoid a risk by restricting the execution of the part of the script as necessary.

The present disclosure describes an object processing apparatus in which the determination unit determines whether to display the object by using the display information, and the control unit outputs the object by using the display information only when the determination unit determines to display the object.

With such a configuration, it is possible to appropriately control the display of the object by restricting the execution of the script as necessary.

The present disclosure describes an object processing apparatus, with respect to the first invention, in which the determination unit determines whether to perform processing related to arrangement of the object, and the control unit performs processing for arranging the object only when the determination unit determines to perform the processing related to the arrangement of the object.

With such a configuration, it is possible to control appropriate object arrangement processing by restricting the execution of the script as necessary.

The present disclosure describes an object processing apparatus in which the object processing apparatus is executed by a terminal apparatus.

With such a configuration, it is possible to avoid a risk in the terminal apparatus by restricting the execution of the script as necessary.

In addition, the present disclosure describes an object processing apparatus in which the data acquisition unit acquires the object data transmitted from the terminal apparatus used by a user.

With such a configuration, even in a case where an object created by a creator that may not be reliable exists in the virtual space, it is possible to avoid a risk by restricting the execution of the script as necessary.

Further, the present disclosure describes an object processing apparatus in which an output unit configured to output the object by using the display information included in the object data is further provided, and the control unit restricts processing of outputting the object by the output unit according to the determination result.

With such a configuration, in a case where an object created by a creator that may not be reliable exists in the virtual space, it is possible to avoid a risk by restricting the output of the object.

The present disclosure describes an object processing apparatus in which an output unit configured to output the object by using the display information included in the object data is further provided, and the control unit restricts at least one processing other than the processing of outputting the object according to the determination result.

With such a configuration, in a case where an object created by a creator that may not be reliable exists in the virtual space, it is possible to avoid a risk by restricting processing other than the output of the object.

According to the object processing apparatus of the present disclosure, it is possible to avoid a risk by restricting the execution of the script as necessary.

### BRIEF DESCRIPTION OF THE DRAWINGS

FIG. 1 is a conceptual diagram of an information system according to an exemplary embodiment;

FIG. 2 is a block diagram of the information system according to the exemplary embodiment;

FIG. 3 is a block diagram of an object processing apparatus according to the exemplary embodiment;

FIG. 4 is a flowchart for describing an operation example of the object processing apparatus according to the exemplary embodiment;

FIG. 5 is a flowchart for describing an example of virtual space output processing according to the exemplary embodiment;

FIG. 6 is a flowchart for describing an example of execution determination processing according to the exemplary embodiment;

FIG. 7 is a flowchart for describing an example of script execution processing according to the exemplary embodiment;

FIG. 8 is a flowchart for describing an example of instruction execution processing according to the exemplary embodiment;

FIG. 9 is a flowchart for describing an operation example of a server according to the exemplary embodiment;

FIG. 10 is a diagram illustrating an example of an execution condition management table according to the exemplary embodiment;

FIG. 11 is a diagram illustrating an example of the execution condition management table according to the exemplary embodiment;

FIG. 12 is a diagram illustrating an example of a user management table according to the exemplary embodiment;

FIG. 13 is a diagram illustrating an example of an object management table according to the exemplary embodiment;

FIG. 14 is a diagram illustrating an example of a virtual space according to the exemplary embodiment;

FIG. 15 is a schematic view of a computer system according to the exemplary embodiment; and

FIG. 16 is a block diagram of the computer system according to the exemplary embodiment.

### DETAILED DESCRIPTION

Hereinafter, exemplary embodiments of an object processing apparatus and the like will be described with reference to the drawings. Note that in the exemplary embodiments, components denoted by the same reference numerals similarly operate, and therefore, the redundant description thereof may be omitted.

### Embodiment

In the exemplary embodiment, an information system including an object processing apparatus that acquires object data arranged in a virtual space, determines whether to perform restriction related to execution of a script included in the object data by using one or more object attribute values related to the object, and restricts the execution of the script according to a determination result will be described.

Note that in the exemplary embodiment, the object data may be a sales target and may be distributed among users. Then, a purchaser of the object may freely create a virtual space by using the object data. Furthermore, the sales can occur to a user who is an original disposal right holder of the object data due to the sale of the object data, and sales information is managed in association with a user identifier of the user. In addition, in a case where such object data includes a script, the script is managed since fraud by the script can be a problem.

Furthermore, the one or more object attribute values include, for example, a producer attribute value, a disposal right holder attribute value, a virtual space attribute value, a dynamic attribute value, and a static attribute value. Furthermore, the restriction processing is, for example, processing for not executing all or a part of the script. In addition, a plurality of restriction processing may be shared by two or more apparatuses. Note that the two or more apparatuses are, for example, a terminal that outputs an object and a server.

In addition, in the present embodiment, a fact that information X is associated with information Y means that the information Y can be acquired from the information X or the information X can be acquired from the information Y, and a method of the association is not limited. The information X and the information Y may be linked, may exist in the same buffer, the information X may be included in the information Y, or the information Y may be included in the information X.

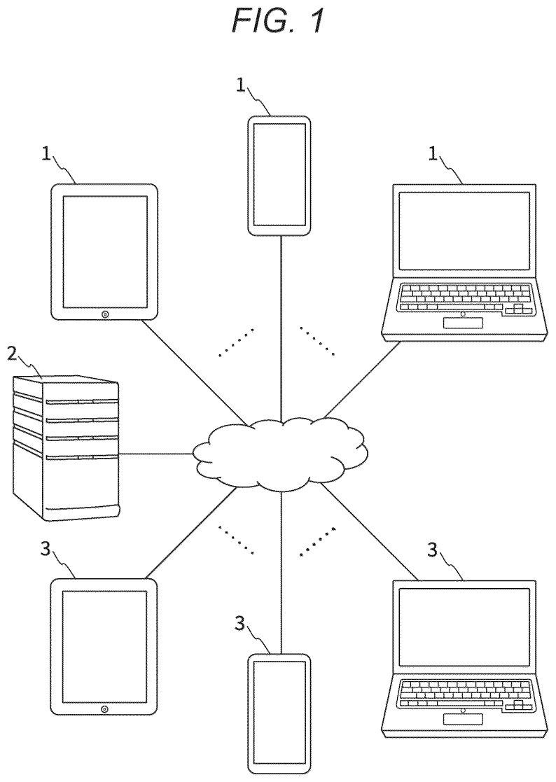

FIG. 1 is a conceptual diagram of an information system A according to the present embodiment. The information system A includes one or two or more object processing apparatuses 1, a server 2, and one or two or more terminal apparatuses 3.

Here, the object processing apparatus 1 is usually a terminal that outputs an object. However, as described later, the object processing apparatus 1 may be a server. Here, the object processing apparatus 1 is mainly an apparatus that determines whether to execute a script included in object data and executes or does not execute the script. Here, the object processing apparatus 1 is mainly a terminal used by a user. The object processing apparatus 1 is, for example, a terminal used by a disposal right holder of an object. Note that the disposal right holder is, for example, a person who has a copyright of the object, or a person who has the legal or de facto authority to reproduce, change, dispose of, or otherwise dispose of the object data by purchasing the object data from an object producer.

The object processing apparatus 1 is, for example, a so-called personal computer, a tablet terminal, a smartphone, a VR device, or the like, and the type thereof is not limited.

The server 2 is, for example, an apparatus that transmits object data to one or two or more object processing apparatuses 1. The server 2 is, for example, an apparatus that transmits world information to one or two or more object processing apparatuses 1. The server 2 is, for example, an apparatus that receives object data from the terminal apparatus 3. The server 2 is, for example, a cloud server or an ASP server, and the type thereof is not limited.

The terminal apparatus 3 is, for example, a terminal used by a producer (may be referred to as a creator) of an object. The terminal apparatus 3 is, for example, a terminal that transmits object data to the server 2 or the object processing apparatus 1. The terminal apparatus 3 is, for example, a so-called personal computer, a tablet terminal, a smartphone, a VR device, or the like, and the type thereof is not limited.

The one or more object processing apparatuses 1 and the server 2, and the server 2 and the one or more terminal apparatuses 3 can communicate with each other via, for example, a network such as the Internet or a LAN.

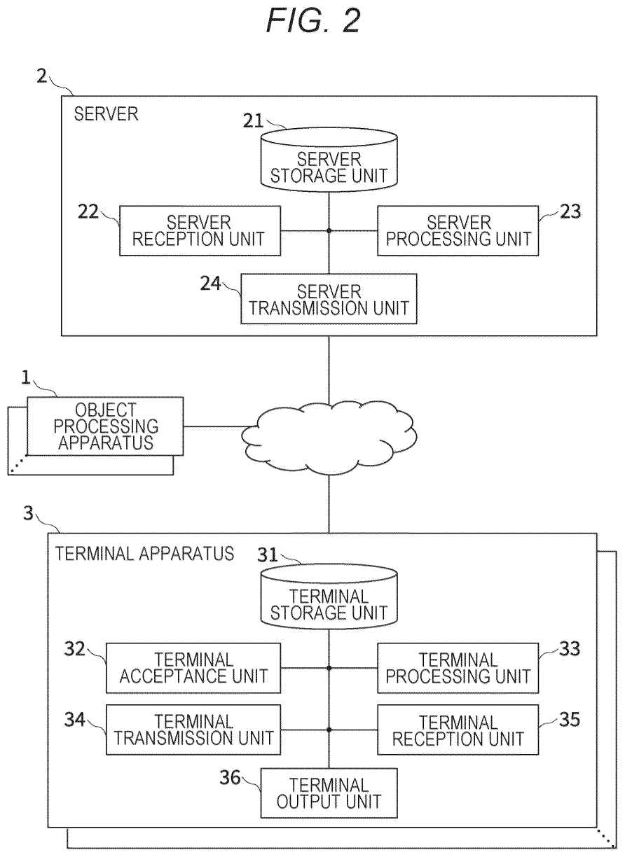

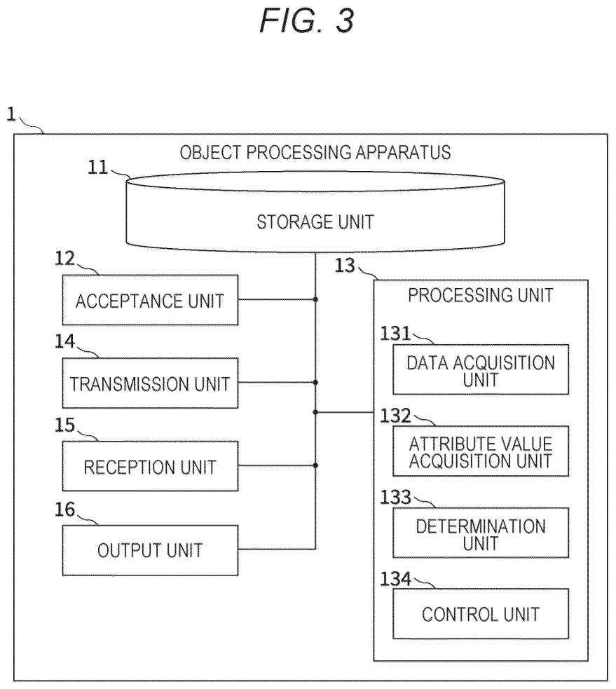

FIG. 2 is a block diagram of the information system A according to the present embodiment. FIG. 3 is a block diagram of the object processing apparatus 1.

The object processing apparatus 1 includes a storage unit 11, an acceptance unit 12, a processing unit 13, a transmission unit 14, a reception unit 15, and an output unit 16. The processing unit 13 includes a data acquisition unit 131, an attribute value acquisition unit 132, a determination unit 133, and a control unit 134.

The server 2 includes a server storage unit 21, a server reception unit 22, a server processing unit 23, and a server transmission unit 24.

The terminal apparatus 3 includes a terminal storage unit 31, a terminal acceptance unit 32, a terminal processing unit 33, a terminal transmission unit 34, a terminal reception unit 35, and a terminal output unit 36.

The storage unit 11 configuring the object processing apparatus 1 stores various types of information. Examples of the various types of information include world information, one or two or more pieces of object data, one or two or more execution conditions, and a user identifier.

The world information is information for configuring the world. The world is a virtual three-dimensional space. The world may be referred to as a virtual space, a place, or the like. The structure of the world information is not limited.

The object data is data related to an object. The object is a display target displayed in the virtual space. The object is, for example, an avatar, an article, a moving body, an animal, a building, or the like, and is not limited thereto. The moving body is, for example, an automobile, a two-wheeled vehicle, a bicycle, or the like, and is not limited thereto. Note that the world may also be considered to be a type of the object.

The object data includes display information. The object data includes, for example, a script. The script is a program for executing processing in the virtual space. The script is executable in the virtual space. The script has one or two or more subprograms. The language of the script is not limited. The script may be an interpreted program or a compiled program. The subprogram is executed by, for example, an API. The subprogram is, for example, an execution module. The processing performed by executing the script is not limited. The script is, for example, a program for displaying an object. The script is, for example, a program for arranging an object in a virtual space. The script is, for example, a program for moving an object in a virtual space. The script is, for example, a program for operating an object. The script is, for example, a program for erasing an object from a virtual space. The script is, for example, a program for changing object data. The script is, for example, a program for changing an object attribute value. The script is, for example, a program for changing world information. The script is, for example, a program for changing a virtual space attribute value. The script is, for example, a program for changing a position, a posture, a display, or the like of an avatar corresponding to a user.

Note that in the above example of the script, the object may be not only an object associated with the script but also an object not associated with the script. The object may be, for example, an object or the like arranged in the virtual space.

The display information is information used when an object is displayed. The display information may be referred to as model information. The object data is associated with, for example, an object identifier.

The model information is information for configuring display of an object such as an avatar. The model information has, for example, mesh information, bone information, and material information. The model information has, for example, a data structure of GL transmission format (glTF). However, the data structure of the model information may be VRM, OBJ, FBX, STL, GLB, COLLADA, or the like, and the type is not limited. Note that the data structure of the display information is not limited.

The object data is associated with, for example, a producer identifier and a disposal right holder identifier. The producer identifier is information for identifying a producer. The producer identifier is, for example, an ID and a producer name. The disposal right holder identifier is an identifier of the disposal right holder of the object data. The disposal right holder identifier is, for example, an ID and a disposal right holder name.

For example, one or two or more object attribute values are associated with the object data. The object attribute value is an attribute value related to object data.

The one or two or more object attribute values include, for example, any one of a producer attribute value, a disposal right holder attribute value, and a virtual space attribute value. The one or more object attribute values may include a subprogram identifier for identifying a subprogram that cannot be executed among the subprograms associated with the object, or a subprogram identifier for identifying a subprogram that can be executed among the subprograms associated with the object. The object attribute value is usually a dynamic attribute value or a static attribute value.

The producer attribute value is an attribute value of the producer of the object data. The producer attribute value is, for example, sales information, review information, and examination history information. Note that one or more producer attribute values configure producer information together with the producer identifier.

The sales information is information related to sales of the object data of the producer. The sales information is, for example, information indicating the sales amount and whether the sales amount is equal to or more than a threshold. Note that for example, in a case where the sales information indicates large sales, it is considered that there is a low possibility that the producer is selling an illegal product.

The review information is review information from a purchaser (user) of the object data. The review information is, for example, a score, a comment, and the number of posts of the review from the user. The score is, for example, a numerical value of any one of five levels from 1 to 5, but is not limited thereto. The comment is a character string, and may be referred to as review, word of mouth, or the like. Furthermore, the review may be a concept including examination, evaluation, and the like. In addition, the review information is, for example, information indicating whether an object that violates or is likely to violate a copyright of a third party is sold, a character string indicating that an object that violates or is likely to violate a copyright of a third party is sold, information indicating whether an object that behaves differently from the description at the time of sale is sold, and a character string indicating that an object that behaves differently from the description at the time of sale is sold.

The examination history information is information indicating a result of examination at the time of uploading the object data, information indicating a result of examination accompanying notification from another user of the object data, and the number of times of examination accompanying notification from another user of the object data.

The disposal right holder attribute value is an attribute value of the disposal right holder of the object data. The disposal right holder attribute value is, for example, BAN/block history information. Note that one or more of the disposal right holder attribute values configure disposal right holder information together with the disposal right holder identifier.

The BAN/block history information is information regarding that the disposal right holder of the object data is prohibited or blocked from participating in the virtual space from another user. The BAN/block history information is, for example, a BAN (prohibited) or a blocked number of times, a BAN (prohibited) or a blocked date and time, and an object identifier.

The virtual space attribute value is an attribute value set in the world. One or more virtual space attribute values may be included in the world information. The virtual space attribute value is, for example, object generation permission information indicating whether to permit generation of an object, object list permission information indicating whether to permit acquisition of an object list, object read permission information indicating whether to permit reading of object data, object write permission information indicating whether to permit writing to object data, user read permission information indicating whether to permit reading of user data, and user write permission information indicating whether to permit writing to user data. The one or more virtual space attribute values may include a subprogram identifier for identifying a subprogram that cannot be executed in the virtual space or a subprogram identifier for identifying a subprogram that can be executed in the virtual space.

Note that the object read permission information and the object write permission information may not be information indicating whether to permit, but may be information specifying restriction due to a distance from a target object. That is, the object read permission information and the object write permission information may be information indicating that reading or writing is not permitted when the distance from the target object is equal to or more than a threshold or more than the threshold.

The dynamic attribute value is an attribute value that dynamically changes. The dynamic attribute value is, for example, a distance from the target object, a distance from a target point in the virtual space, sales information, review information, examination history information, and BAN/block history information.

The static attribute value is an attribute value that does not dynamically change. The fact that it does not dynamically change may not mean that it cannot change at all. For example, the static attribute value does not dynamically change among the virtual space attribute values. That is, the virtual space attribute value that can be changed at any time by the creator (for example, may be referred to as an operator) of the world may be considered to correspond to the dynamic attribute value.

The execution condition is a condition for determining whether to execute a script. The execution condition may be a restriction condition or a permission condition. The restriction condition is a condition for determining not to execute a script. The permission condition is a condition for determining to execute a script. The execution condition is associated with, for example, a subprogram. The execution condition is associated with, for example, a subprogram identifier. The subprogram identifier is, for example, API information, a module name, a function name, a method name, a message name, and an ID.

The execution condition is usually a condition based on one or more object attribute values. The restriction condition among the execution conditions is a condition indicating that the target object does not satisfy a certain degree of reliability, and is, for example, “sales information<=threshold A (for example, 10,000 yen)”, “average value of scores of review information<=threshold B (for example, “2”)”, “number of times of examination as examination history information>=threshold C (for example, “3”)”, and “a BAN (prohibited) or a blocked number of times as BAN/block history information>=threshold D (for example, “1”)”. Furthermore, the restriction condition may be a condition set for each world (virtual space) in which the target object is arranged, and is, for example, “object generation permission information=NG”, “object list permission information=NG”, “object write permission information=NG”, “user read permission information=NG”, and “user write permission information=NG”. Note that the “number of times of examination” is the number of times of examination at the time of object upload, notification from another user, or the like, but may be the number of times of ineligibility (may be referred to as NG, inappropriate, or the like) as a result of examination.

The permission condition among the execution conditions is a condition indicating that the target object satisfies a certain degree of reliability, and is, for example, “sales information>threshold A (for example, 10,000 yen)”, “average value of scores of review information>threshold B (for example, “2”)”, “number of times of examination as examination history information<threshold C (for example, “3”)”, and “a BAN (prohibited) or a blocked number of times as BAN/block history information<threshold D (for example, “1”)”. Furthermore, the execution condition may be a condition set for each world (virtual space) in which the target object is arranged, and is, for example, “object generation permission information=OK”, “object list permission information=OK”, “object write permission information=OK”, “user read permission information=NG”, and “user write permission information=OK”.

The user identifier is information for identifying a user who uses the object processing apparatus 1. The user identifier is, for example, a user ID, a name, a telephone number, or a mail address. The user identifier may be, for example, a producer identifier or a disposal right holder identifier. Note that one or more user attribute values may be stored in the storage unit 11 in association with the user identifier.

The acceptance unit 12 accepts various types of information and instructions. The various types of information and instructions are, for example, a download instruction and an instruction for an object.

The download instruction is an instruction to download world information and one or two or more pieces of object data. In response to the download instruction, for example, the world information and the one or more pieces of object data are downloaded from the server 2, and the object processing apparatus 1 outputs a virtual space and one or more objects. The instruction to the object is, for example, an instruction to move the object, an instruction to operate the object, or an instruction to delete the object. Note that the content of the instruction for the object may be various and is not limited. The instruction to move the object is, for example, an instruction to raise an arm of the object or an instruction to raise a leg of the object.

Note that the acceptance here is usually acceptance of information input from an input device such as a keyboard, a mouse, or a touch panel, but may be reception from the server 2, acceptance of information read from a recording medium such as an optical disk, a magnetic disk, or a semiconductor memory, or the like.

An input unit of the various types of information and instruction may be any unit such as a touch panel, a keyboard, a mouse, and a menu screen.

The processing unit 13 performs various types of processing. The various types of processing are, for example, processing performed by the data acquisition unit 131, the attribute value acquisition unit 132, the determination unit 133, and the control unit 134.

The processing unit 13 configures a virtual space by using, for example, world information. The processing unit 13 configures a virtual space by using, for example, world information received from the server 2. The processing unit 13 configures a virtual space by using, for example, world information received from the terminal apparatus 3 of the producer. Note that one or two or more virtual space attribute values are associated with the world information.

The processing unit 13 configures one or more objects to be output by using, for example, display information of one or two or more objects. The processing unit 13 configures an object by using, for example, display information included in object data received from the server 2. The processing unit 13 configures an object by using, for example, display information included in object data received from the terminal apparatus 3 of the producer.

The data acquisition unit 131 acquires object data. Note that a timing and a trigger at which the data acquisition unit 131 acquires the object are not limited. In addition, the object data includes display information of the object displayed in the virtual space and an executable script.

The data acquisition unit 131 acquires, for example, object data transmitted from the terminal apparatus 3 used by the user.

The data acquisition unit 131 acquires, for example, one or two or more pieces of object data stored in the storage unit 11.

The data acquisition unit 131 receives, for example, one or two or more pieces of object data from the server 2. Note that the object data of the server 2 is, for example, object data transmitted from the terminal apparatus 3. Note that one or two or more object attribute values are associated with the received object data.

The attribute value acquisition unit 132 acquires one or more object attribute values related to object data. The attribute value acquisition unit 132 acquires, for example, one or more object attribute values associated with the object data from the storage unit 11. The attribute value acquisition unit 132 receives, for example, one or more object attribute values associated with the object data from the server 2 or the terminal apparatus 3.

Here, the one or more object attribute values include, for example, one or two or more types of attribute values among a producer attribute value, a disposal right holder attribute value, and a virtual space attribute value. The one or more object attribute values include, for example, a dynamic attribute value or/and a static attribute value.

The determination unit 133 acquires a determination result as to whether to execute the script included in the object data, the determination result being a determination result made by using the one or more object attribute values acquired by the attribute value acquisition unit 132. For example, the determination unit 133 determines whether to execute the script included in the object data by using the one or two or more object attribute values acquired by the attribute value acquisition unit 132, and acquires a determination result. Note that such processing is appropriately referred to as execution determination processing. In addition, the determination result is, for example, information indicating whether to execute a script, and a subprogram identifier (for example, the API) to be executed. Note that the determination as to whether to execute the script is usually performed by the determination unit 133, but the determination unit 133 may acquire a determination result performed by another apparatus (for example, the server 2).

For example, the determination unit 133 determines whether the one or more object attribute values acquired by the attribute value acquisition unit 132 satisfy one or two or more execution conditions, and acquires a determination result.

For example, the determination unit 133 determines whether to display the object by using the display information. For example, the determination unit 133 determines whether to perform processing related to arrangement of the object.

Note that a timing and a trigger of the determination performed by the determination unit 133 are not limited. For example, the determination unit 133 performs the above execution determination processing with the acquisition of new object data by the data acquisition unit 131 as a trigger.

For example, the determination unit 133 of the object processing apparatus 1 may perform only a part of determination among the execution determination processing. For example, the determination unit 133 may perform one or two or more types of execution determination processing among execution determination processing using one or more producer attribute values and execution determination processing using one or more disposal right holder attribute values, and other execution determination processing such as execution determination processing using one or more virtual space attribute values may be performed by the server processing unit 23 of the server 2.

The control unit 134 restricts the execution of the script according to the determination result acquired by the determination unit 133. The control unit 134 executes or does not execute the script included in the object data according to the determination result acquired by the determination unit 133. The control unit 134 executes or does not execute the subprogram included in the script included in the object data according to the determination result acquired by the determination unit 133.

For example, in a case where the determination result is information indicating that the script is not executed, the control unit 134 performs restriction processing for not executing the script. For example, in a case where the determination result is information indicating that the script is executed, the control unit 134 performs script execution processing.

The restriction processing is processing for not executing all or a part of the script. The restriction processing may include restriction processing for each of two or more restrictions. The restriction processing is, for example, processing of writing a restriction flag associated with the script or the subprogram. The restriction processing is, for example, processing of associating a permission flag only with the subprogram in which the determination result indicates that it is executed. The restriction processing is, for example, deleting the script or the subprogram included in the object data. The restriction processing is, for example, temporarily deleting the script or the subprogram included in the object data. The restriction processing may be considered to include not executing the script or the subprogram included in the object data.

The restriction flag is information indicating that the script or the subprogram is not executed. The permission flag is information indicating that the script or the subprogram is executed.

For example, the control unit 134 performs only a part of the restriction processing among the two or more restriction processing. Note that in such a case, the restriction processing of other parts is performed by the server 2, for example. Only a part of restriction processing is restriction processing for only a part of subprograms.

The control unit 134 executes only the subprogram determined to be executed by the determination unit 133. For example, the control unit 134 executes only the subprogram with which the restriction flag is not associated. For example, the control unit 134 executes only the subprogram with which the permission flag is associated.

For example, the control unit 134 outputs the object by using the display information only when the determination unit 133 determines to display the object. Note that here, the processing of outputting the object is realized by executing the script.

Here, the output is usually display on a display or projection using a projector, but may be a concept including printing by a printer, sound output, transmission to an external apparatus, accumulation on a recording medium, delivery of a processing result to another processing apparatus, another program, or the like.

For example, only when the determination unit 133 determines to perform processing related to arrangement of an object, the control unit 134 performs processing for arranging the object. Note that here, the processing for arranging the object is realized by executing the script. The processing for arranging the object is, for example, processing of displaying the object at a predetermined position in the virtual space. The processing for arranging the object is, for example, processing of moving the object to a next point in the virtual space.

For example, the control unit 134 restricts the processing in which the output unit 16 outputs the object according to the determination result. Restricting the processing of outputting the object only needs to result in no output of the object, and the processing performed by the control unit 134 is not limited. For example, in a case where a program pointer moves to a head of the subprogram that outputs the object, the control unit 134 may perform processing of jumping the program pointer to skip the subprogram. In a case where a message instructing the output of the object is accepted, the control unit 134 may not execute a method corresponding to the message, or may add a restriction flag in association with the subprogram that outputs the object.

For example, the control unit 134 may restrict at least one processing other than the processing of outputting the object according to the determination result. As a result of such restriction, the corresponding processing may not be performed.

For example, after performing the restriction processing, the control unit 134 may perform up to execution of an executable script or subprogram, or may perform only the restriction processing.

The transmission unit 14 transmits various types of instructions and information. The various types of instructions and information are, for example, a download instruction, an instruction for an object, and object data.

The reception unit 15 receives various types of information. The various types of information are, for example, world information and one or two or more pieces of object data. The reception unit 15 receives various types of information from the server 2 or the terminal apparatus 3, for example.

The output unit 16 outputs the object by using the display information included in the object data. The output unit 16 outputs an object configured by using the display information.

The output unit 16 outputs, for example, an execution result of the script in the control unit 134. The execution result of the script is, for example, a changed object or a moved object.

Here, the output is usually display on a display or projection using a projector, but may be a concept including printing by a printer, sound output, transmission to an external apparatus, accumulation on a recording medium, delivery of a processing result to another processing apparatus, another program, or the like.

The server storage unit 21 configuring the server 2 stores various types of information. The various types of information are, for example, one or two or more pieces of world information, one or two or more virtual space attribute values associated with each piece of world information, one or two or more pieces of object data, one or two or more object attribute values associated with each piece of object data, one or two or more pieces of producer information, one or two or more pieces of disposal right holder information, and one or two or more execution conditions. Note that the world information is usually associated with a virtual space identifier. The virtual space identifier may be referred to as a virtual space identifier. The object data is usually associated with an object identifier. Furthermore, the world information is associated with object data of each of one or more objects arranged in the virtual space output by the world information.

The server reception unit 22 receives various types of information and instructions. The various types of information and instructions are, for example, a download instruction, an instruction for an object, a disposal right holder change instruction, one or two or more pieces of world information, one or two or more virtual space attribute values associated with the world information, one or two or more pieces of object data, one or two or more pieces of producer information, and one or two or more pieces of disposal right holder information.

The disposal right holder change instruction is an instruction to change the disposal right holder of the object data. The disposal right holder change instruction usually has an object identifier and a disposal right holder identifier. The disposal right holder identifier is an identifier of a new disposal right holder of the object.

For example, the server reception unit 22 receives a download instruction from the object processing apparatus 1. The server reception unit 22 receives, for example, an instruction for an object from the object processing apparatus 1. The server reception unit 22 receives, for example, world information and object data from the terminal apparatus 3. For example, the server reception unit 22 receives a disposal right holder change instruction from the terminal apparatus 3.

The server processing unit 23 performs various types of processing. The server processing unit 23 acquires, for example, world information corresponding to the download instruction, one or more virtual space attribute values, and one or two or more pieces of object data from the server storage unit 21.

For example, the server processing unit 23 changes the disposal right holder of the object data in response to the received disposal right holder change instruction. For example, the server processing unit 23 changes the disposal right holder identifier paired with the object identifier included in the received disposal right holder change instruction to the disposal right holder identifier included in the received disposal right holder change instruction.

The server processing unit 23 performs, for example, the same processing as the processing performed by the determination unit 133. Furthermore, the server processing unit 23 performs, for example, the same processing as the processing performed by the control unit 134. That is, the server processing unit 23 performs the above-described execution determination processing on, for example, the received object data or the object data included in the received instruction or the like. The server processing unit 23 performs execution determination processing by using, for example, each of one or two or more execution conditions of the server storage unit 21.

The server transmission unit 24 transmits various types of information. The various types of information are, for example, world information, one or more virtual space attribute values, one or two or more pieces of object data, one or more object attribute values, producer information, and disposal right holder information.

The terminal storage unit 31 configuring the terminal apparatus 3 stores various types of information. The various types of information are, for example, a user identifier. The user identifier may be, for example, a producer identifier or a disposal right holder identifier.

The terminal acceptance unit 32 accepts various types of instructions and information. The various types of instructions and information are, for example, object data, world information, and a disposal right holder change instruction. The object data and the world information are, for example, information created by a creator who is a user of the terminal apparatus 3.

An upload instruction is an instruction to upload object data or/and world information to the server 2.

In addition, acceptance here is usually acceptance of information input from an input device such as a keyboard, a mouse, a touch panel, or a controller of a VR device, but may be reception from another apparatus, acceptance of information read from a recording medium such as an optical disk, a magnetic disk, or a semiconductor memory, or the like.

An input unit of various types of instructions and information may be any unit such as a touch panel, a keyboard, a mouse, and a menu screen.

The terminal processing unit 33 performs various types of processing. The various types of processing are, for example, processing of forming a data structure for transmitting accepted instructions and information, and processing of forming a data structure for outputting received information.

The terminal transmission unit 34 transmits various types of instructions and information. The various types of instructions and information are, for example, object data, world information, and an upload instruction.

The terminal reception unit 35 receives various types of instructions and information. The various types of instructions and information are, for example, information indicating a result of uploading object data or world information.

The terminal output unit 36 outputs various types of information. The various types of information are, for example, information indicating a result of upload.

Here, the output is usually display on a display or projection using a projector, but may be a concept including printing by a printer, sound output, transmission to an external apparatus, accumulation on a recording medium, delivery of a processing result to another processing apparatus, another program, or the like.

In one aspect, the storage unit 11, the server storage unit 21, and the terminal storage unit 31 are a nonvolatile recording medium, but can also be realized by a volatile recording medium.

The process of storing information in the storage unit 11 or the like is not limited. For example, information may be stored in the storage unit 11 or the like via a recording medium, information transmitted via a communication line or the like may be stored in the storage unit 11 or the like, or information input via an input device may be stored in the storage unit 11 or the like.

The acceptance unit 12 and the terminal acceptance unit 32 can be realized by a device driver of an input unit such as a touch panel or a keyboard, control software of a menu screen, or the like.

The processing unit 13, the data acquisition unit 131, the attribute value acquisition unit 132, the determination unit 133, the control unit 134, the server processing unit 23, and the terminal processing unit 33 can be usually realized by a processor, a memory, or the like. The processing procedure of the processing unit 13 and the like is usually realized by software, and the software is recorded in a recording medium such as a ROM. However, it may be realized by hardware (dedicated circuit). Note that the processor is a CPU, an MPU, a GPU, or the like, and the type thereof is not limited.

The transmission unit 14, the server transmission unit 24, and the terminal transmission unit 34 are usually realized by a wireless or wired communication unit, but may be realized by a broadcasting unit.

The reception unit 15, the server reception unit 22, and the terminal reception unit 35 are usually realized by a wireless or wired communication unit, but may be realized by a unit of receiving broadcast.

The output unit 16 and the terminal output unit 36 may be considered to include or not include an output device such as a display or a speaker. The output unit 16 can be realized by driver software of an output device, driver software of an output device and an output device, or the like.

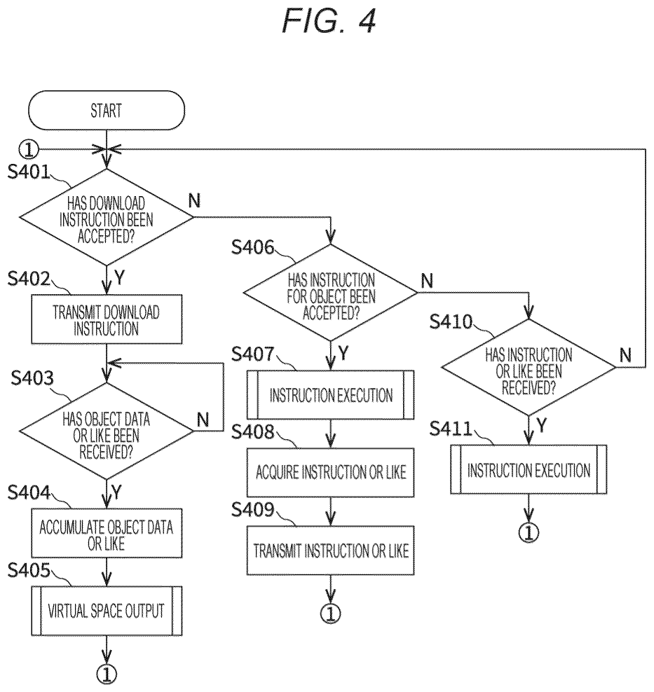

Next, an operation example of the information system A will be described. First, an operation example of the object processing apparatus 1 will be described with reference to the flowchart of FIG. 4.

(Step S401) The acceptance unit 12 determines whether a download instruction has been accepted. When the download instruction has been accepted, the processing proceeds to step S402, and when the download instruction has not been accepted, the processing proceeds to step S406.

(Step S402) The processing unit 13 configures a download instruction to be transmitted. The transmission unit 14 transmits a download instruction to the server 2. Note that the download instruction to be transmitted includes, for example, a virtual space identifier for specifying world information.

(Step S403) The reception unit 15 determines whether the world information and the one or more pieces of object data corresponding to the download instruction transmitted in step S402 have been received from the server 2. When the world information or the like has been received, the processing proceeds to step S404, and when it has not been received, the processing returns to step S403.

(Step S404) The processing unit 13 at least temporarily accumulates the received world information and the one or more pieces of object data in the storage unit 11.

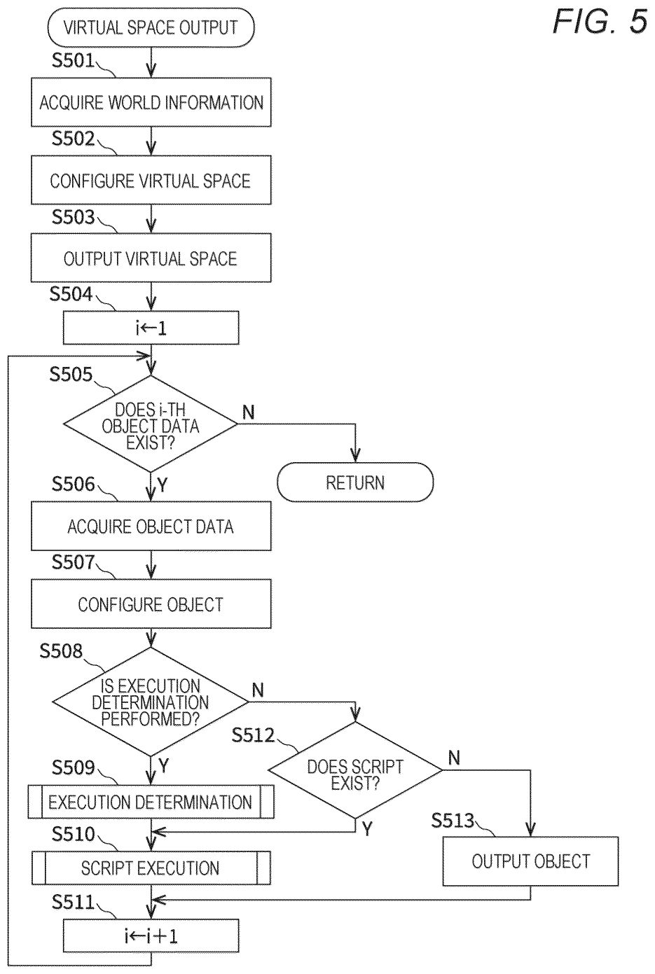

(Step S405) The processing unit 13 or the like performs virtual space output processing by using the world information and the one or more pieces of object data accumulated in the storage unit 11. The processing returns to step S401. An example of the virtual space output processing will be described with reference to the flowchart of FIG. 5. Note that the virtual space output processing is an instruction to acquire the virtual space and the one or more pieces of object data.

(Step S406) The acceptance unit 12 determines whether the output instruction for the object in the virtual space has been accepted. When the instruction has been accepted, the processing proceeds to step S407, and when the instruction has not been accepted, the processing proceeds to step S410.

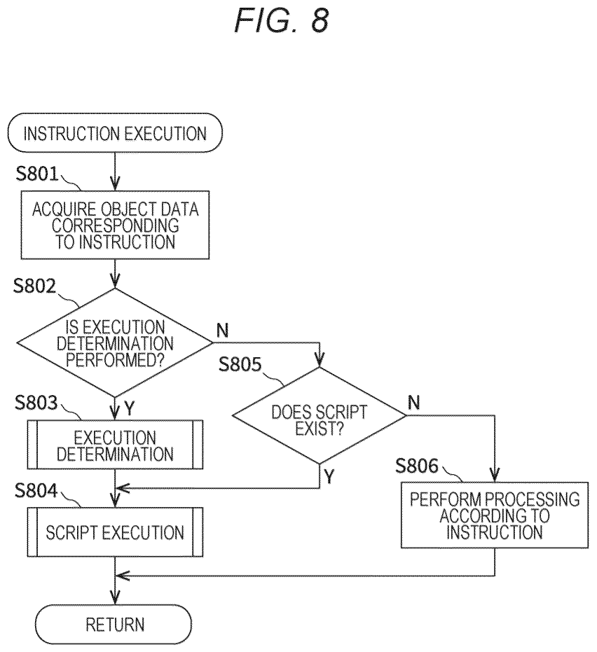

(Step S407) The processing unit 13 or the like executes processing for the instruction accepted in step S406. An example of such instruction execution processing will be described with reference to the flowchart of FIG. 8.

(Step S408) The processing unit 13 acquires an instruction or the like to be transmitted to the server 2. Note that such an instruction or the like includes the instruction accepted in step S406. Such an instruction or the like includes, for example, object data of an object corresponding to the instruction accepted in step S406.

(Step S409) The transmission unit 14 transmits the instruction or the like acquired in step S408 to the server 2. The processing returns to step S401.

(Step S410) The reception unit 15 determines whether an instruction or the like has been received from the server 2. When the instruction or the like has been received, the processing proceeds to step S411, and when the instruction or the like has not been received, the processing returns to step S401. Such an instruction or the like is, for example, information based on an instruction given by another user to an object in another object processing apparatus 1. Such an instruction or the like includes, for example, object data of an object in response to an instruction made by another user. Such an instruction or the like includes, for example, a script identifier of a script to be executed in response to an instruction made by another user or a subprogram identifier of a subprogram to be executed.

(Step S411) The processing unit 13 or the like executes processing for the instruction accepted in step S406. The processing returns to step S401. An example of such instruction execution processing will be described with reference to the flowchart of FIG. 8.

Note that in the flowchart of FIG. 4, the processing ends by interruption of power off or processing end.

Next, an example of the virtual space output processing of step S405 will be described with reference to the flowchart of FIG. 5.

(Step S501) The processing unit 13 acquires world information from the storage unit 11. Note that the world information is, for example, world information transmitted from the server 2.

(Step S502) The processing unit 13 configures a virtual space to be output by using the world information acquired in step S501.

(Step S503) The output unit 16 outputs the virtual space configured in step S502.

(Step S504) The processing unit 13 substitutes 1 for a counter i.

(Step S505) The processing unit 13 determines whether object data of an i-th object to be output exists in the storage unit 11. When the i-th object data exists, the processing proceeds to step S506, and when the i-th object data does not exist, the processing returns to host processing. Note that such object data is, for example, object data transmitted from the server 2 in association with the world information.

(Step S506) The processing unit 13 acquires the object data of the i-th object to be output from the storage unit 11.

(Step S507) The processing unit 13 configures an object to be output by using display information included in the object data acquired in step S506.

(Step S508) The determination unit 133 determines whether to execute a script for the object data acquired in step S506. The processing proceeds to step S509 when the execution determination of the script is performed, and the processing proceeds to step S512 when the execution determination is not performed.

Note that the determination unit 133 determines whether to perform a script execution determination based on, for example, any one or two or more pieces of information of the producer information, the disposal right holder information, and the world information. For example, in a case where the disposal right holder identifier corresponding to the object data is a specific disposal right holder identifier (for example, its own identifier), the determination unit 133 determines not to perform the script execution determination. For example, when the producer identifier corresponding to the object data is a specific producer identifier (for example, an identifier of a provider of the world information), the determination unit 133 determines not to perform the script execution determination.

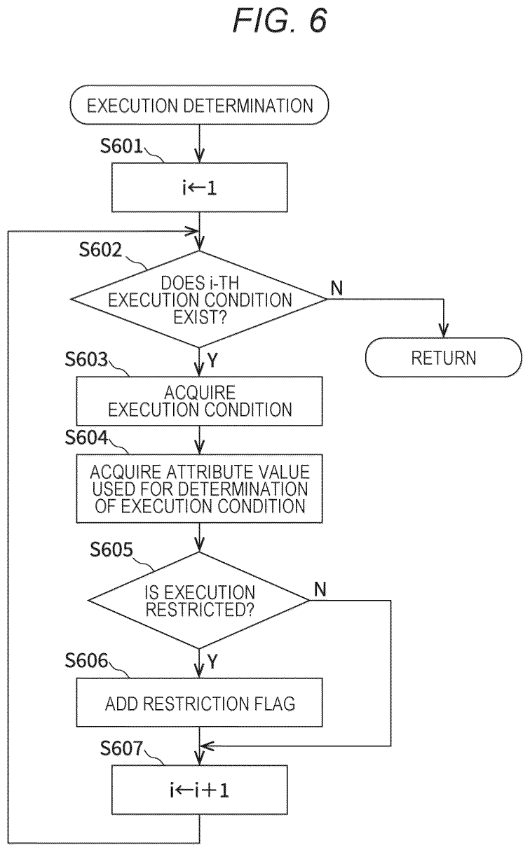

(Step S509) The determination unit 133 determines whether to execute a script included in the object data acquired in step S506. An example of the execution determination processing will be described with reference to the flowchart of FIG. 6. Note that the determination as to whether to execute a script usually includes determination as to whether to execute a subprogram included in the script.

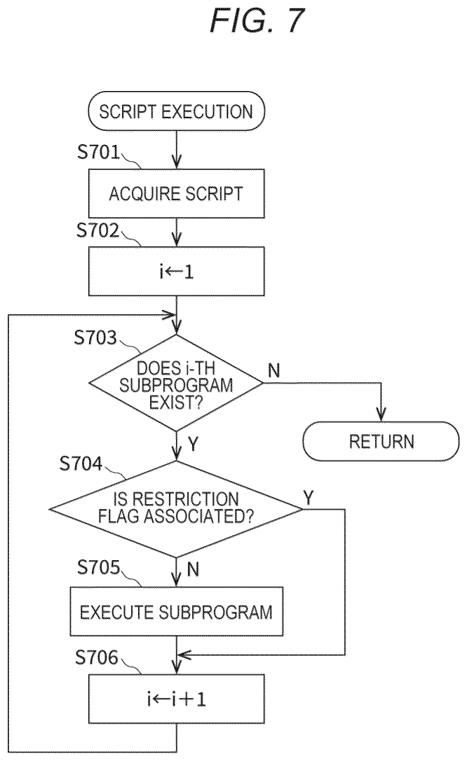

(Step S510) The control unit 134 performs script execution processing according to the determination result in step S509. An example of the script execution processing will be described with reference to the flowchart of FIG. 7.

(Step S511) The processing unit 13 increments the counter i by 1. The processing returns to step S505.

(Step S512) The determination unit 133 determines whether the object data acquired in step S506 includes a script. When the script is included, the processing proceeds to step S510, and when the script is not included, the processing proceeds to step S513.

(Step S513) The output unit 16 outputs the object configured in step S507. The processing proceeds to step S511.

Next, an example of the execution determination processing in step S509 will be described with reference to the flowchart of FIG. 6.

(Step S601) The determination unit 133 substitutes 1 for the counter i.

(Step S602) The determination unit 133 determines whether an i-th execution condition exists in the storage unit 11. In a case where the i-th execution condition exists, the processing proceeds to step S603, and in a case where the i-th execution condition does not exist, the processing returns to host processing.

(Step S603) The determination unit 133 acquires the i-th execution condition from the storage unit 11.

(Step S604) The attribute value acquisition unit 132 acquires one or two or more object attribute values to be used for determination of the i-th execution condition.

The attribute value acquisition unit 132 acquires, for example, an object attribute value corresponding to information for specifying the object attribute value associated with the i-th execution condition. For example, the attribute value acquisition unit 132 analyzes the i-th execution condition, determines the information for specifying the object attribute value associated with the i-th execution condition, and acquires an object attribute value corresponding to the information.

(Step S605) The determination unit 133 determines whether the one or more object attribute values acquired in step S604 satisfy the i-th execution condition. As a result of the determination in the determination unit 133, in a case where execution of a subprogram corresponding to the i-th execution condition is restricted, the processing proceeds to step S606, and in a case where the execution of the subprogram corresponding to the i-th execution condition is not restricted, the processing proceeds to step S607. The result of the determination as to whether the i-th execution condition is satisfied is a determination as to whether to restrict the execution of the subprogram.

Here, the determination unit 133 may acquire the determination result from the server 2 without determining whether the execution condition is satisfied. That is, the server 2 may determine whether one or more object attribute values satisfy the execution condition, and the determination unit 133 may only read the determination result from the server 2. Note that a timing at which the object processing apparatus 1 acquires the determination result from the server 2 is not limited. The determination unit 133 may acquire the determination result from the server 2 when the determination result is necessary, or may acquire the determination result from the server 2 when the object data is acquired.

Note that a timing at which the determination unit 133 reads the determination result from the server 2 is not limited. For example, in a case where a request for acquiring a determination result of execution of a script is received from a terminal, or in a case where object data is uploaded, the determination unit 133 reads the script or the determination result corresponding to the object data from the server 2.

In addition, when the server 2 makes a determination and the server 2 executes a script, the server 2 may execute the script and transmit display data as a result of the execution to the terminal.

(Step S606) The control unit 134 adds a restriction flag in association with the subprogram corresponding to the i-th execution condition. The restriction flag is associated with a subprogram that is not executed.

(Step S607) The determination unit 133 increments the counter i by 1. The processing returns to step S602.

In the flowchart of FIG. 6, the control unit 134 may add a permission flag in association with only the subprogram determined to be executed. In addition, the control unit 134 may perform the restriction processing described above other than adding the flag.

Next, an example of script execution processing in step S510 will be described with reference to the flowchart of FIG. 7.

(Step S701) The control unit 134 acquires a script included in the object data.

(Step S702) The control unit 134 substitutes 1 for the counter i.

(Step S703) The control unit 134 determines whether the i-th subprogram exists in the script acquired in step S701. When the i-th subprogram exists, the processing proceeds to step S704, and when the i-th subprogram does not exist, the processing proceeds to step S706.

(Step S704) The control unit 134 determines whether a restriction flag is associated with the i-th subprogram. In a case where the restriction flag is associated, the processing proceeds to step S706, and in a case where the restriction flag is not associated, the processing proceeds to step S705.

(Step S705) The control unit 134 executes the i-th subprogram.

(Step S706) The control unit 134 increments the counter i by 1. The processing returns to step S703.

In the flowchart of FIG. 7, the control unit 134 does not execute the subprogram determined not to be executed but may execute the subprogram determined to be executed. That is, it is not essential for the control unit 134 to perform the execution control of the subprogram based on the restriction flag.

Next, an example of instruction execution processing in step S407 will be described with reference to the flowchart of FIG. 8.

(Step S801) The determination unit 133 acquires object data corresponding to a target instruction.

(Step S802) The determination unit 133 determines whether to perform an execution determination on the object data acquired in step S801. When the execution determination is performed, the processing proceeds to step S803, and when the execution determination is not performed, the processing proceeds to step S805. Note that the processing here may be the same as the processing in step S508.

(Step S803) The determination unit 133 determines whether to execute the script included in the object data acquired in step S801. An example of the execution determination processing has been described with reference to the flowchart of FIG. 6.

(Step S804) The control unit 134 performs script execution processing according to the determination result in step S803. The processing returns to host processing. An example of the script execution processing has been described with reference to the flowchart of FIG. 7.

(Step S805) The determination unit 133 determines whether the object data acquired in step S801 includes a script. When the script is included, the processing proceeds to step S804, and when the script is not included, the processing proceeds to step S806.

(Step S806) The processing unit 13 performs processing according to the target instruction. The processing returns to host processing.

Note that the processing unit 13 configures an object to be output by using, for example, display information included in the object data, and the output unit 16 outputs the object.

In the flowchart of FIG. 8, the determination unit 133 acquires a subprogram identifier corresponding to the instruction, searches for an execution condition related to restriction on execution of the subprogram identified by the subprogram identifier from one or more execution conditions of the storage unit 11, and determines whether only the execution condition is satisfied. This is because the determination processing is speeded up.

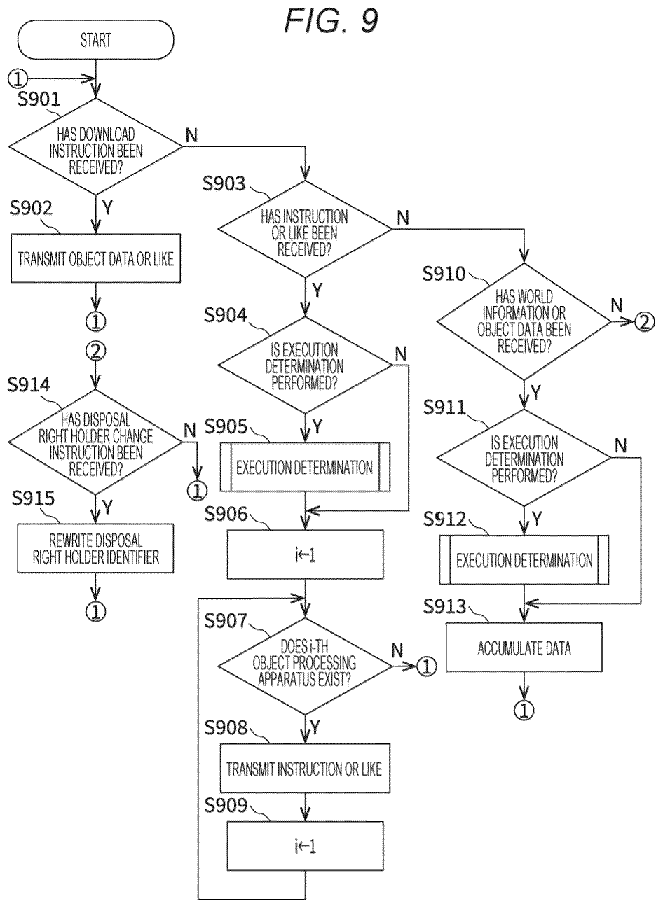

Next, an operation example of the server 2 will be described with reference to the flowchart of FIG. 9.

(Step S901) The server reception unit 22 determines whether a download instruction has been received from the object processing apparatus 1. When the download instruction has been received, the processing proceeds to step S902, and when the download instruction has not been received, the processing proceeds to step S903.

(Step S902) The server processing unit 23 acquires world information and one or more pieces of object data corresponding to the download instruction from the server storage unit 21. The server transmission unit 24 transmits the world information and the one or more pieces of object data to the object processing apparatus 1 that has transmitted the download instruction. The processing returns to step S901.

Note that the server processing unit 23 accumulates the information of the object processing apparatus 1 that has transmitted the world information and the like in the server storage unit 21. Such an object processing apparatus 1 is an operating terminal that currently outputs a virtual space and an object. The information of the object processing apparatus 1 is, for example, an IP address and a user identifier of the object processing apparatus 1.

(Step S903) The server processing unit 23 determines whether an instruction or the like for the object has been received from the object processing apparatus 1. When the instruction or the like has been received, the processing proceeds to step S904, and when the instruction or the like has not been received, the processing proceeds to step S910.

(Step S904) The server processing unit 23 determines whether to perform a script execution determination of the object corresponding to the instruction or the like. When the execution determination is performed, the processing proceeds to step S905, and when the execution determination is not performed, the processing proceeds to step S906. Note that such processing may be the same as the processing in step S508.

(Step S905) The server processing unit 23 performs the script execution determination of the object corresponding to the instruction or the like. Such execution determination processing is the same as the processing described in the flowchart of FIG. 6.

(Step S906) The server processing unit 23 substitutes 1 for the counter i.

(Step S907) The server processing unit 23 refers to the server storage unit 21 and determines whether an i-th object processing apparatus 1 exists. When the i-th object processing apparatus 1 exists, the processing proceeds to step S908, and when the i-th object processing apparatus 1 does not exist, the processing returns to step S901.

The i-th object processing apparatus 1 is, for example, the i-th object processing apparatus 1 among the currently operating object processing apparatuses 1. The i-th object processing apparatus 1 is, for example, the i-th object processing apparatus 1 among the object processing apparatuses 1 corresponding to the object (for example, an avatar) existing in the world including the object corresponding to the instruction or the like.

(Step S908) The server transmission unit 24 transmits the received instruction or the like to the i-th object processing apparatus 1. The server transmission unit 24 may transmit the object data of the object corresponding to the instruction or the like to the i-th object processing apparatus 1.

(Step S909) The server processing unit 23 increments the counter i by 1. The processing returns to step S907.

(Step S910) The server reception unit 22 determines whether world information or object data has been received from the terminal apparatus 3. When the information has been received, the processing proceeds to step S911, and when the information has not been received, the processing proceeds to step S914.

(Step S911) The server processing unit 23 determines whether the information received in step S910 is object data and whether to perform an execution determination. When such a condition is satisfied, the processing proceeds to step S912, and when the condition is not satisfied, the processing proceeds to step S913.

(Step S912) The server processing unit 23 performs the execution determination of the script included in the received object data. Such execution determination processing is the same as the processing described in the flowchart of FIG. 6.

Note that as a result of the execution determination here, restriction processing for restricting the execution of all or a part of the subprograms of the script included in the object data is performed.

(Step S913) The server processing unit 23 accumulates the received world information or object data, or the object data as a result of the execution determination in step S912, in the server storage unit 21. The processing returns to step S901.

Note that the object data accumulated in the server storage unit 21 is data obtained as a result of performing necessary restriction processing.

(Step S914) The server reception unit 22 determines whether a disposal right holder change instruction has been received from the terminal apparatus 3. The processing proceeds to step S915 when the disposal right holder change instruction has been received, and the processing returns to step S901 when the disposal right holder change instruction has not been received.

(Step S915) The server processing unit 23 rewrites the disposal right holder identifier paired with the object identifier included in the disposal right holder change instruction with the disposal right holder identifier included in the disposal right holder change instruction. The processing returns to step S901.

Note that in the flowchart of FIG. 9, for example, before transmitting one or two or more pieces of object data to the object processing apparatus 1 in response to the download instruction, the server processing unit 23 may perform execution determination processing on the one or more pieces of object data to be transmitted.

In addition, in the flowchart of FIG. 9, the processing is ended by interruption of power off or processing end.

Further, in the flowchart of FIG. 9, for example, the disposal right holder change instruction may be an object data sales instruction. That is, the change of the disposal right holder identifier corresponding to the object data is, for example, that the object data is sold from a disposal right holder identified by an original disposal right holder identifier to a disposal right holder identified by a new disposal right holder identifier.

Furthermore, in the flowchart of FIG. 9, in a case where the object data is sold, the price of the sold object data is added to the sales information corresponding to the original disposal right holder identifier and updated.

Next, an operation example of the terminal apparatus 3 will be described. The terminal acceptance unit 32 accepts, for example, object data or world information from a user who is a creator. Next, the terminal processing unit 33 acquires a user identifier of the terminal storage unit 31, and associates the user identifier with the object data or the world information. Next, the terminal transmission unit 34 transmits the object data or the world information associated with the user identifier to the server 2. With the above processing, the object data or the world information created by the creator is registered in the server 2.

Further, the terminal acceptance unit 32 accepts a disposal right holder change instruction from a purchaser who is a user who has purchased the object data, for example. Next, the terminal processing unit 33 acquires a user identifier (here, the disposal right holder identifier) from the terminal storage unit 31, and configures a disposal right holder change instruction having the user identifier. Note that the disposal right holder change instruction has an object identifier of the object data purchased by the user. Next, the terminal transmission unit 34 transmits the disposal right holder change instruction including the disposal right holder identifier and the object identifier to the server 2. By such processing, the disposal right holder of the object data is changed.

Hereinafter, a specific operation example of the information system A in the present embodiment will be described.

It is assumed that the server storage unit 21 of the object processing apparatus 1 stores world information associated with a virtual space identifier “W001” and one or two or more virtual space attribute values. It is assumed that a set of virtual space attribute values is “<object generation permission information>OK<object list permission information>OK<object write permission information>NG<user read permission information>OK<user write permission information>NG”. Note that two or more pieces of world information and a virtual space attribute value associated with the world information may be stored in the server storage unit 21.

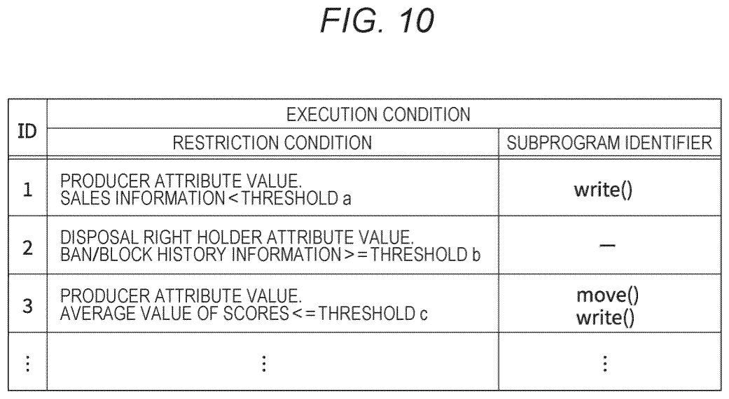

In addition, it is assumed that an execution condition management table illustrated in FIG. 10 is stored in the storage unit 11. The execution condition management table is a table that manages one or two or more execution conditions. Here, it is assumed that the execution condition management table of the object processing apparatus 1 stores, for example, an execution condition related to a producer attribute value and a disposal right holder attribute value. The execution condition management table manages one or more records having “ID” and “execution condition”. Here, the “execution condition” has a “restriction condition” and a “script identifier”. The “ID” is information for identifying a record. The “restriction condition” is a condition for not executing the script. The “subprogram identifier” is an identifier of a subprogram that is not executed when the “restriction condition” is satisfied. Here, the identifier of the subprogram is a module name (may be referred to as a function name or a method name).

The record of “ID=1” in FIG. 10 indicates that, when the sales information in the producer attribute value associated with the object data is less than a threshold a (here, for example, “10,000 yen”), a subprogram corresponding to a subprogram identifier “write( )” among the scripts included in the object data is not executed. The subprogram identified by the subprogram identifier “write( )” is a module that rewrites the object data or the world information.

The record of “ID=2” in FIG. 10 indicates that, when the BAN/block history information in the disposal right holder attribute value associated with the object data is equal to or more than a threshold b (here, for example, “2”), all the scripts included in the object data are not executed. When the script identifier is “-”, it indicates that all the subprograms included in the object data are not executed.

The record of “ID=3” in FIG. 10 indicates that a subprogram corresponding to subprogram identifiers “move( )” and “write( )” among the scripts included in the object data is not executed when the average value of the scores in the producer attribute values associated with the object data is equal to or less than a threshold c (here, for example, “3”). Note that the subprogram identified by the subprogram identifier “move( )” is a module that moves an object in the virtual space.

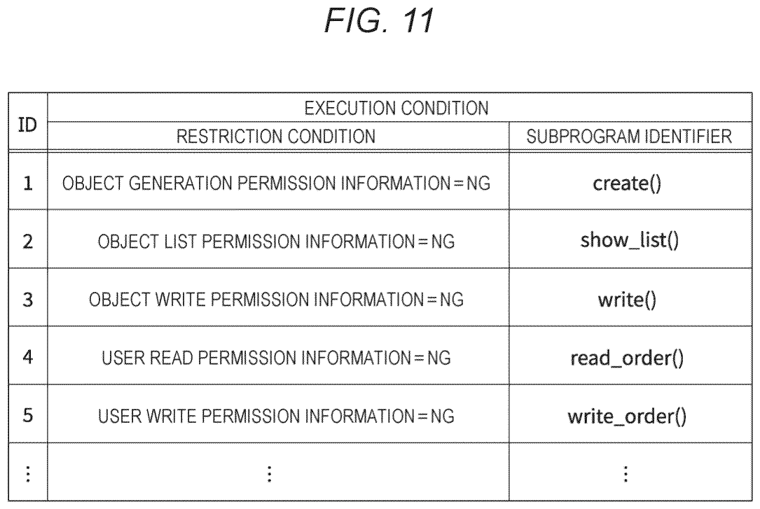

In addition, it is assumed that the execution condition management table illustrated in FIG. 11 is stored in the server storage unit 21 configuring the server 2. Here, it is assumed that the execution condition related to the virtual space attribute value is stored in the execution condition management table of the server 2.

The record of “ID=1” in FIG. 11 indicates that a subprogram corresponding to a subprogram identifier “create( )” is not executed when the object generation permission information is “NG” (information indicating that generation of an object is not permitted). Note that the “create( )” is a module that generates object data.

Note that in a case where the restriction conditions in FIGS. 10 and 11 are satisfied, the subprogram identifier paired with the restriction condition is acquired. The subprogram identified by such a subprogram identifier is not executed. That is, when a subprogram identifier is acquired for execution of a subprogram, it is determined whether the subprogram identifier is an identifier of a subprogram that is not executed, and when the subprogram identifier is not a subprogram that is not executed, the subprogram is executed.

Furthermore, the subprograms identified by the subprogram identifiers (for example, write( ) move( ) create( ) in FIGS. 10 and 11 are provided on a platform side, for example. Note that the platform side is usually the server 2. In such a case, since the subprogram and the subprogram identifier defined in advance on the platform side can be specified, it is possible to determine whether the subprogram may be executed.

The record of “ID=2” indicates that a subprogram corresponding to a subprogram identifier “show list( )” is not executed when the object list permission information is “NG” (information indicating that the output of the list of objects is not permitted). Note that the “show list( )” is a module that outputs a list of objects.

The record of “ID=3” indicates that the subprogram corresponding to the subprogram identifier “write( )” is not executed when the object write permission information is “NG” (information indicating that writing (change) to the object data is not permitted). Note that the “write( )” is a module that performs writing (changing) with respect to the object data.

The record of “ID=4” indicates that a subprogram corresponding to a subprogram identifier “read order( )” is not executed when the user read permission information is “NG” (information indicating that reading of the user data is not permitted). Note that the “read order( )” is a module that performs reading of the user data.

The record of “ID=5” indicates that a subprogram corresponding to a subprogram identifier “write order( )” is not executed when the user write permission information is “NG” (information indicating that writing to the user data is not permitted). Note that the “write order( )” is a module that performs writing of the user data.

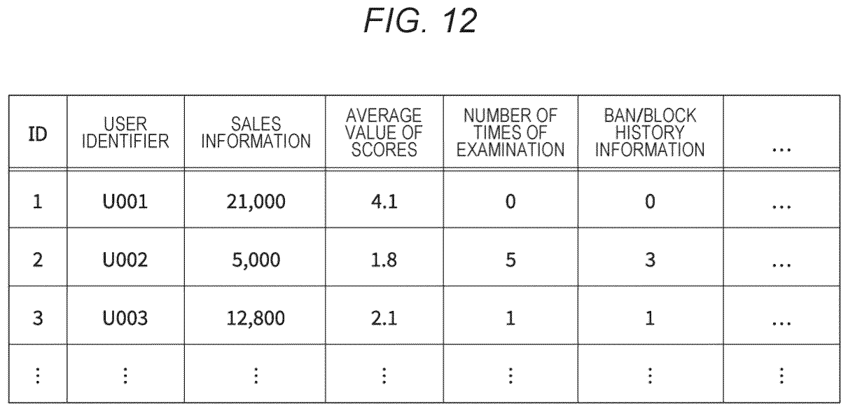

In addition, it is assumed that a user management table illustrated in FIG. 12 is stored in the server storage unit 21 configuring the server 2. The user management table is a table that manages user information. The user management table manages one or more records having “ID”, “user identifier”, “sales information”, “average value of scores”, “number of times of examination”, and “BAN/block history information”. Note that the user may be a producer or a disposal right holder. Furthermore, the user is an operator of the terminal apparatus 3, and may be a person corresponding to an avatar in the virtual space. The information configuring the user management table is based on, for example, information transmitted from the terminal apparatus 3. That is, for example, a score associated with the user identifier, an examination request associated with the user identifier, and a BAN or block request associated with the user identifier are transmitted from the terminal apparatus 3 to the server 2. In addition, for example, a purchase instruction of the object data is transmitted from the terminal apparatus 3 to the server 2, and the server 2 increases the sales information of the user identified by the disposal right holder identifier paired with the object identifier of the object data in response to the purchase instruction.

The “average value of scores” is an average value of scores included in review information transmitted from each of one or two or more users. The “number of times of examination” is the number of times of examination at the time of object upload, notification from another user, or the like, but may be the number of times of ineligibility (may be referred to as NG, inappropriate, or the like) as a result of examination. In addition, the user management table may have an “evaluation value” acquired by using two or more attribute values. The “evaluation value” is a score of the evaluation of the user. The “evaluation value” is acquired, for example, based on one or more object attribute values such as “sales information”, “number of times of examination”, and “BAN/block history information”. The “evaluation value” is acquired by using, for example, an arithmetic expression using one or more object attribute values as parameters. For the “evaluation value”, for example, a vector closest to a vector having two or more object attribute values as elements is acquired from a correspondence table, and an evaluation value paired with the vector is acquired from the correspondence table. Note that the correspondence table here includes two or more pieces of correspondence information including a vector having two or more object attribute values as elements and an evaluation value. Furthermore, the “evaluation value” is acquired, for example, by giving one or more object attribute values and a learning module to a prediction module of machine learning and executing the prediction module. Note that the learning model is information configured by learning processing of machine learning, and is information used for prediction processing of machine learning. The learning model is information acquired by giving two or more pieces of teacher data having one or more object attribute values and an evaluation value to a learning module of machine learning and executing the learning module. Note that a machine learning algorithm may be deep learning, random forest, decision tree, or SVR, and it is not limited. Furthermore, for the machine learning, for example, various types of machine learning functions such as a TensorFlow library, a random forest module of R language, fastText, TinySVM, and the like and various existing libraries can be used.

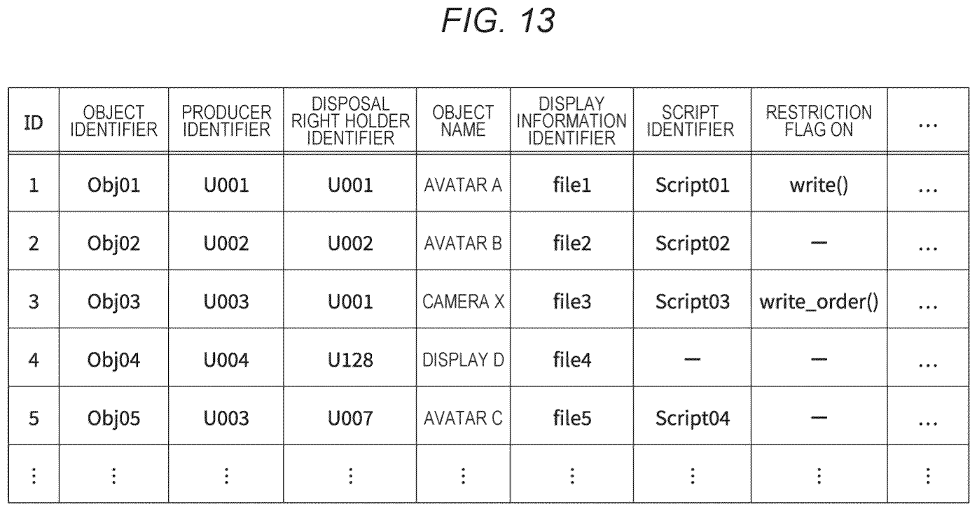

Further, it is assumed that the server storage unit 21 configuring the server 2 stores an object management table illustrated in FIG. 13. It is assumed that the object management table in FIG. 13 is associated with, for example, one piece of world information identified by the virtual space identifier “W001”. That is, here, the object management table is a table that manages object data of an object arranged in the one virtual space. The object management table manages one or more records having “ID”, “object identifier”, “producer identifier”, “disposal right holder identifier”, “object name”, “display information identifier”, “script identifier”, and “restriction flag ON”.

The “display information identifier” is information for identifying the display information, and is, for example, a file name.

In addition, it is assumed that the script identified by the “script identifier” is stored in the server storage unit 21. The script identified by the “script identifier” may be integrated with the display information or may be linked based on the script identifier. Note that the object data (for example, data of “ID=4”) corresponding to a script identifier “-” does not have a script.

The “restriction flag ON” is a subprogram identifier to which a restriction flag is attached. For example, when object data is received, the server processing unit 23 acquires one or more virtual space attribute values (here, the virtual space attribute value paired with the virtual space identifier “W001”) corresponding to the object data from the server storage unit 21, and acquires a subprogram identifier corresponding to “restriction flag ON” by using the one or more virtual space attribute values and referring to the execution condition management table (FIG. 11). The one or more virtual space attribute values include “<object write permission information>NG<user write permission information>NG”.

The “restriction flag ON” of “ID=1” indicates that the subprogram “write( )” included in a script “Script01” cannot be executed. In addition, the “restriction flag ON” of “ID=2” indicates that there is no subprogram to be restricted on the server 2 side among the subprograms included in a script “Script02”. The “restriction flag ON” of “ID=3” indicates that the subprogram “write order( )” included in a script “Script03” cannot be executed.

In such a situation, it is assumed that a user X identified by a user identifier “U001” inputs a download instruction having the virtual space identifier “W001” to the object processing apparatus 1 of the own terminal.

Next, the acceptance unit 12 of the object processing apparatus 1 accepts the download instruction. The processing unit 13 configures a download instruction to be transmitted. The transmission unit 14 transmits the download instruction to the server 2. Note that the download instruction to be transmitted includes, for example, the virtual space identifier “W001” for specifying world information and the user identifier “U001”.

Next, the server reception unit 22 of the server 2 receives the download instruction from the object processing apparatus 1.

Next, the server processing unit 23 acquires the world information identified by the virtual space identifier “W001” included in the received download instruction from the server storage unit 21.

In addition, the server processing unit 23 acquires a set of object data corresponding to the virtual space identifier “W001” included in the received download instruction from the object management table in FIG. 13. Note that the server processing unit 23 also acquires the display information specified by the “display information identifier” of each record of the object management table (FIG. 13) from the server storage unit 21.

Next, the server transmission unit 24 transmits the acquired world information and the plurality of pieces of object data to the object processing apparatus 1 that has transmitted the download instruction.

Next, the reception unit 15 of the object processing apparatus 1 receives the world information and the plurality of pieces of object data corresponding to the transmitted download instruction from the server 2. Next, the processing unit 13 temporarily accumulates the received world information, the plurality of pieces of object data, and the like in the storage unit 11.

Next, the processing unit 13 or the like of the object processing apparatus 1 performs virtual space output processing as follows by using the world information and the plurality of pieces of object data accumulated in the storage unit 11. Note that such processing is the processing described with reference to the flowchart of FIG. 5.

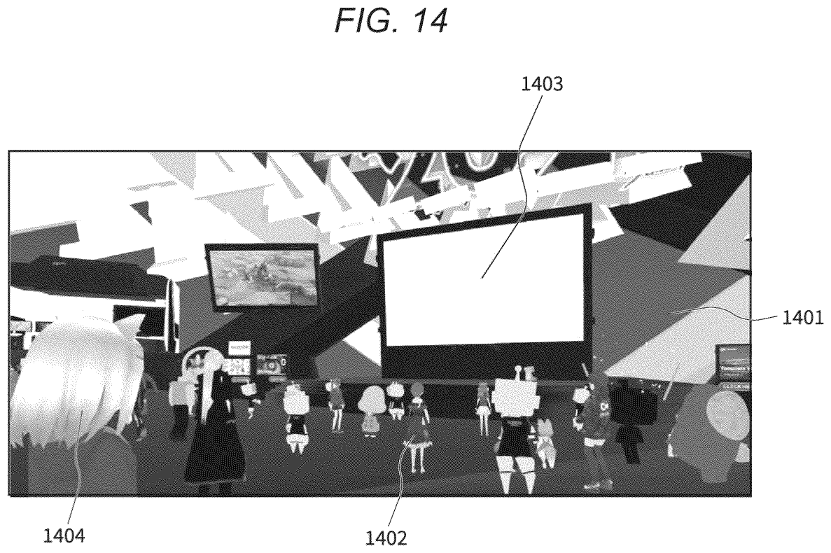

That is, first, the processing unit 13 acquires world information from the storage unit 11, and configures a virtual space by using the world information. Next, the output unit 16 outputs the configured virtual space to the display. An example of such a virtual space is 1401 in FIG. 14. Such a virtual space 1401 is a field of a virtual event.

Next, the processing unit 13 acquires display information included in each object data in the storage unit 11, and configures an object.

Next, the determination unit 133 determines whether to execute a script included in the object data for each object data. That is, the determination unit 133 acquires the subprogram identifier corresponding to the restriction flag received from the server 2 for each object. In addition, the determination unit 133 refers to the execution condition management table (FIG. 10) of the storage unit 11 for each object data and performs determination as to whether to restrict the execution of the script, or acquires a subprogram identifier to restrict the execution of the script. Here, the determination unit 133 acquires “BAN/block history information=3” paired with a disposal right holder identifier “U002” paired with an object identifier “Obj02” of the object management table (FIG. 13), determines that the “BAN/block history information=3” satisfies the restriction condition of “ID=2” of the execution condition management table (FIG. 10), and determines not to execute all the scripts of the object identified by the object identifier “Obj02”. As a result, the object identified by the object identifier “Obj02” is not displayed in the virtual space.

Further, for example, the determination unit 133 determines to restrict the execution of the subprogram corresponding to the subprogram identifier “write( )” of the object identified by an object identifier “Obj01”, and adds a restriction flag in association with the subprogram.

Furthermore, the determination unit 133 determines to restrict execution of a subprogram corresponding to the subprogram identifier “write order( )” of the object identified by an object identifier “Obj03”, for example, and adds a restriction flag in association with the subprogram.

In addition, the determination unit 133 refers to the execution condition management table (FIG. 10), and adds the restriction flag in association with the script of the object satisfying the restriction condition or the subprogram of the object satisfying the restriction condition by using one or more producer attribute values or/and one or more disposal right holder attribute values of each object.

Next, the control unit 134 displays the object in the virtual space except for the object to which the restriction flag is attached in association with the entire script or the object to which the restriction flag is attached in association with a subprogram “show( )”. The subprogram “show( )” is a subprogram for displaying an object.

An example of such a virtual space is illustrated in FIG. 14. In FIG. 14, for example, an avatar identified by the object identifier “Obj01” is 1402. In FIG. 14, the display identified by an object identifier “Obj04” is 1403. Further, in FIG. 14, an avatar identified by an object identifier “Obj05” is 1404.

Furthermore, for example, it is assumed that the virtual space in FIG. 14 is also output to the object processing apparatus 1 of a user Y identified by “user identifier=U007”.

Then, it is assumed that the user Y inputs a movement instruction to the object processing apparatus 1 of the user Y in order to move the object (object identifier=Obj05) of the user Y in the virtual space. Note that a method of inputting a user's instruction is not limited. A drag by a finger or a mouse may be used, a menu item may be selected, a button may be pressed, or the like.

Next, the acceptance unit 12 of the object processing apparatus 1 of the user Y accepts the movement instruction having the object identifier “Obj05”. Next, the processing unit 13 or the like of the object processing apparatus 1 performs the following processing on the accepted movement instruction.

First, the determination unit 133 acquires a subprogram identifier “move( )” corresponding to the movement instruction. Note that it is assumed that a subprogram identifier is associated with various types of instructions. Next, the determination unit 133 searches a “script identifier” including the acquired subprogram identifier “move( )” from the execution condition management table (FIG. 10), and acquires a restriction condition “producer attribute value.average value of scores<=threshold c (here, “3”)” paired with the “script identifier”. This restriction condition is the restriction condition of “ID=3” in FIG. 10.

Next, the determination unit 133 acquires “producer attribute value.average value of scores”, which is an attribute value used to determine the acquired restriction condition, as follows. That is, the determination unit 133 acquires the object data identified by the object identifier “Obj05” corresponding to the movement instruction. Next, the determination unit 133 refers to the object management table (FIG. 13) and acquires a producer identifier “U003” paired with the object identifier “Obj05”. Next, the determination unit 133 refers to the user management table (FIG. 12) and acquires an average value “2.1” of the scores paired with the producer identifier “U003”. Next, the determination unit 133 determines that the average value “2.1” of the acquired scores satisfies the acquired restriction condition “producer attribute value.average value of scores<=3”.

Next, the control unit 134 adds a restriction flag in association with the subprogram “move( )” included in the script included in the object data identified by the object identifier “Obj05”.

Then, the control unit 134 does not execute the subprogram “move( )”. As a result, the avatar (1404 in FIG. 14) identified by the object identifier “Obj05” cannot move.

Note that in the present specific example, it is assumed that the subprogram “move( )” included in the object data identified by the object identifier “Obj05” includes, for example, a code of processing of moving the avatar, rewriting a script of another object, or deleting another object data.

As described above, according to the present embodiment, it is possible to avoid a risk by restricting the execution of the script as necessary.

In addition, according to the present embodiment, it is possible to appropriately avoid a risk by performing determination using the appropriate object attribute value and restricting the execution of the script according to the determination result.

In addition, according to the present embodiment, it is possible to appropriately avoid a risk by restricting the execution of the part of scripts as necessary. Note that a part of scripts are subprograms.

In addition, according to the present embodiment, load distribution can be performed by sharing the restriction of execution of a part of scripts as necessary by two or more apparatuses.

Note that according to the present embodiment, the processing for restricting the execution of the script is shared by the object processing apparatus 1 and the server 2, which are terminals. However, in the present embodiment, all the processing for restricting the execution of the script may be performed by the object processing apparatus 1 or may be performed by the server 2.

Furthermore, in the present embodiment, the object processing apparatus 1 may be a server for the terminal apparatus 3. FIG. 3 is a block diagram of the object processing apparatus 1 in such a case. The acceptance unit 12 of the object processing apparatus 1 in such a case receives various types of instructions and information from the terminal apparatus 3. Furthermore, the storage unit 11 of the object processing apparatus 1 in such a case may include various types of information of the server storage unit 21. Furthermore, the object processing apparatus 1 in such a case can perform various types of processing of the server 2 described above. Furthermore, the object processing apparatus 1 transmits world information and object data to, for example, the terminal apparatus 3. Then, the terminal apparatus 3 receives the world information and the object data, and outputs a virtual space as illustrated in FIG. 14, for example.

Furthermore, the processing in the present embodiment may be realized by software. Then, the software may be distributed by software download or the like. In addition, the software may be recorded on a recording medium such as a CD-ROM and distributed. Note that this also applies to other embodiments in the present specification. Note that software that realizes the object processing apparatus 1 in the present embodiment is the following program. That is, this program is a program for causing a computer to function as: a data acquisition unit configured to acquire object data including display information of an object displayed in a virtual space and an executable script; an attribute value acquisition unit configured to acquire one or more object attribute values related to the object data; a determination unit configured to determine whether to execute the script included in the object data by using the one or more object attribute values and acquire a determination result; a control unit configured to execute or not to execute the script according to the determination result; and an output unit configured to output the object by using the display information included in the object data.

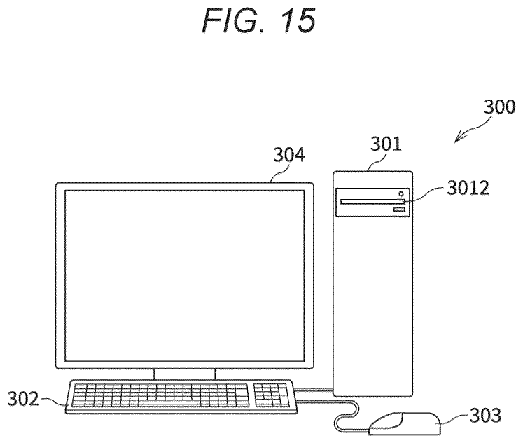

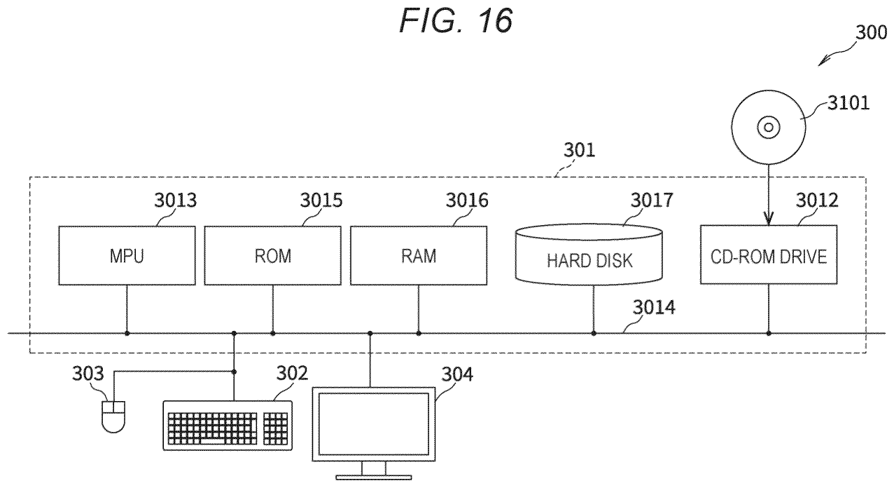

Furthermore, FIG. 15 illustrates an appearance of a computer that executes the program described in the present specification to realize the object processing apparatus 1 and the like of the various embodiments described above. The above-described embodiments can be realized by computer hardware and a computer program executed on the computer hardware. FIG. 15 is a schematic diagram of this computer system 300, and FIG. 16 is a block diagram of the system 300.

In FIG. 15, the computer system 300 includes a computer 301 including a CD-ROM drive, a keyboard 302, a mouse 303, and a monitor 304.

In FIG. 16, in addition to a CD-ROM drive 3012, the computer 301 includes an MPU 3013, a bus 3014 coupled to the CD-ROM drive 3012 or the like, a ROM 3015 for storing a program such as a boot-up program, a RAM 3016 coupled to the MPU 3013 for temporarily storing an instruction of an application program and providing a temporary storage space, and a hard disk 3017 for storing an application program, a system program, and data. The computer 301 may further include a network card that provides connection to a LAN.

A program for causing the computer system 300 to execute the functions of the object processing apparatus 1 and the like of the above-described embodiments may be stored in the CD-ROM 3101, inserted into the CD-ROM drive 3012, and further transferred to the hard disk 3017. Alternatively, the program may be transmitted to the computer 301 via a network and stored in the hard disk 3017. The program is loaded into the RAM 3016 at the time of execution. The program may be directly loaded from the CD-ROM 3101 or the network.

The program may not necessarily include an operating system (OS), a third-party program, or the like that causes the computer 301 to execute the functions of the object processing apparatus 1 of the above-described embodiment and the like. The program only needs to include a portion of an instruction that calls an appropriate function (module) in a controlled manner to obtain a desired result. How the computer system 300 operates is well known, and a detailed description thereof will be omitted.

Note that in the above program, the step of transmitting information, the step of receiving information, and the like do not include processing performed by hardware, for example, processing performed by a modem, an interface card, or the like in the transmission step (processing performed only by hardware).

The number of computers that execute the program may be one or more. That is, centralized processing or distributed processing may be performed.

Further, in each of the above embodiments, it goes without saying that two or more communication units existing in one apparatus may be physically realized by one medium.

Furthermore, in each of the above embodiments, each processing may be realized by being centrally processed by a single apparatus, or may be realized by being distributedly processed by a plurality of apparatuses.

The present disclosure is not limited to the above embodiments, and various modifications can be made, and it goes without saying that they are also included in the scope of the present disclosure.

As described above, the object processing apparatus according to the present disclosure has an effect of being able to avoid a risk by restricting execution of a script as necessary, and is useful as an object processing apparatus or the like.

What is claimed is:

1. A non-transitory computer-readable storage medium storing computer-readable instructions thereon which, when executed by a computer, cause the computer to perform a method, the method comprising:
acquiring object data including display information of an object displayed in a virtual space and a script for executing processing in the virtual space;
acquiring one or more object attribute values related to the object data;
acquiring a determination result as to whether to execute the script included in the object data, the determination result being a result of determination performed by using the one or more object attribute values; and
restricting execution of the script according to the determination result.

2. The non-transitory computer-readable storage medium according to claim 1, wherein the one or more object attribute values include a producer attribute value that is an attribute value of a producer of the object data.

3. The non-transitory computer-readable storage medium according to claim 1, wherein the one or more object attribute values include a disposal right holder attribute value that is an attribute value of a disposal right holder of the object data.

4. The non-transitory computer-readable storage medium according to claim 1, wherein the one or more object attribute values include a virtual space attribute value that is an attribute value set in the virtual space.

5. The non-transitory computer-readable storage medium according to claim 1, wherein the one or more object attribute values include a dynamic attribute value that dynamically changes.

6. The non-transitory computer-readable storage medium according to claim 1, wherein the one or more object attribute values include a static attribute value that does not dynamically change.

7. The non-transitory computer-readable storage medium according to claim 1, further comprising:
performing restriction processing for not executing the script in a case where the determination result is information indicating that the script is not executed, wherein
the restriction processing includes
processing for not executing a part of processing among a plurality of processing included in the script.

8. The non-transitory computer-readable storage medium according to claim 1, further comprising:
performing restriction processing for not executing the script in a case where the determination result is information indicating that the script is not executed, wherein
the restriction processing includes restriction processing for each of two or more restrictions, and
performing only a part of restriction processing among the restriction processing for each of the two or more restrictions.

9. The non-transitory computer-readable storage medium according to claim 1, further comprising:
wherein the script includes a subprogram that executes each of two or more types of processing,
acquiring a determination result as to whether to execute for each of the subprograms; and
executing only the subprogram determined to be executed.

10. The non-transitory computer-readable storage medium according to claim 1, further comprising:
determining whether to display the object by using the display information; and
outputting the object by using the display information only in response to a determination to display the object.

11. The non-transitory computer-readable storage medium according to claim 1, further comprising:
determining whether to perform processing related to arrangement of the object; and
arranging the object only in response to a determination to perform processing related to arrangement of the object.

12. The non-transitory computer-readable storage medium according to claim 1, further comprising:
determining whether to execute the script included in the object data by using the one or more object attribute values and acquiring a determination result.

13. The non-transitory computer-readable storage medium according to claim 1, further comprising:
acquiring the object data transmitted from a terminal apparatus used by a user.

14. The non-transitory computer-readable storage medium according to claim 1, further comprising:
outputting the object by using the display information included in the object data; and
restricting processing of outputting the object according to the determination result.

15. The non-transitory computer-readable storage medium according to claim 1, further comprising:
outputting the object by using the display information included in the object data; and
restricting at least one processing other than the processing of outputting the object according to the determination result.

16. An object processing method, comprising:
acquiring object data including display information of an object displayed in a virtual space and a script for executing processing in the virtual space;
acquiring one or more object attribute values related to the object data;
acquiring a determination result as to whether to execute the script included in the object data, the determination result being a result of determination performed by using the one or more object attribute values;
restricting execution of the script according to the determination result; and
outputting the object by using the display information included in the object data.

17. An object processing apparatus, comprising:
processing circuitry configured to
acquire object data including display information of an object displayed in a virtual space and a script for executing processing in the virtual space;
acquire one or more object attribute values related to the object data;
acquire a determination result as to whether to execute the script included in the object data, the determination result being a result of determination performed by using the one or more object attribute values; and
restrict execution of the script according to the determination result.
